(19) United States
(12) Patent Application Publication
(10) Pub. No.: US 2010/0260387 A1
(43) Pub. Date: Oct. 14, 2010

(54) IMAGE CAPTURE DEVICE AND SUBJECT RECOGNITION METHOD USING THE SAME

(75) Inventors: HOU-HSIEN LEE, Tu-Cheng (TW); CHANG-JUNG LEE, Tu-Cheng (TW); CHIH-PING LO, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/436,762

(22) Filed: May 6, 2009

(30) Foreign Application Priority Data
Apr. 10, 2009 (CN) 200910301463.0

(51) Int. Cl. G06K 9/00; H04N 5/228; H04N 5/76

(52) U.S. Cl. 382/118; 348/222.1; 348/231.99; 382/105; 348/E05.031

(57) ABSTRACT

An image capture device determines whether a subject with an image captured by the image capture device is a target subject. The image capture device captures a primary image of the target subject and an image of the subject, senses tilt angles relative to the horizon of capturing the primary image and the image to be tested, and transmits an image process command to rotate the primary image to generate a plurality of sample images with different tilt angles. The image capture device further transmits a selection command to select a sample image with a tilt angle approximately equal to the second tilt angle, and compares the image of the subject and the selected sample image to determine whether the subject is the target subject.

### BACKGROUND

1. Technical Field

The present disclosure relates to image capture devices, and particularly to an image capture device and a subject recognition method applied the image capture device.

2. Description of Related Art

Image capture devices are frequently utilized to provide site security, via face recognition, and traffic/vehicle management and control via vehicle license plate recognition (VLPR). However, the subject is often difficult or impossible to recognize when a lens of the image capture device rotates to match the position of the subject.

### BRIEF DESCRIPTION OF THE DRAWINGS

FIG. 1 is a block diagram of an exemplary embodiment of an image capture device utilizing an image capture module.

FIG. 2 is a sketch map of a plurality of sample images included in the image capture device of FIG. 1.

FIG. 3 is similar to FIG. 2, but shows the image capture module of FIG. 1 rotated by about 45°.

FIG. 4 is a flowchart of an exemplary embodiment of a subject recognition method using the image capture device of FIG. 1.

### DETAILED DESCRIPTION

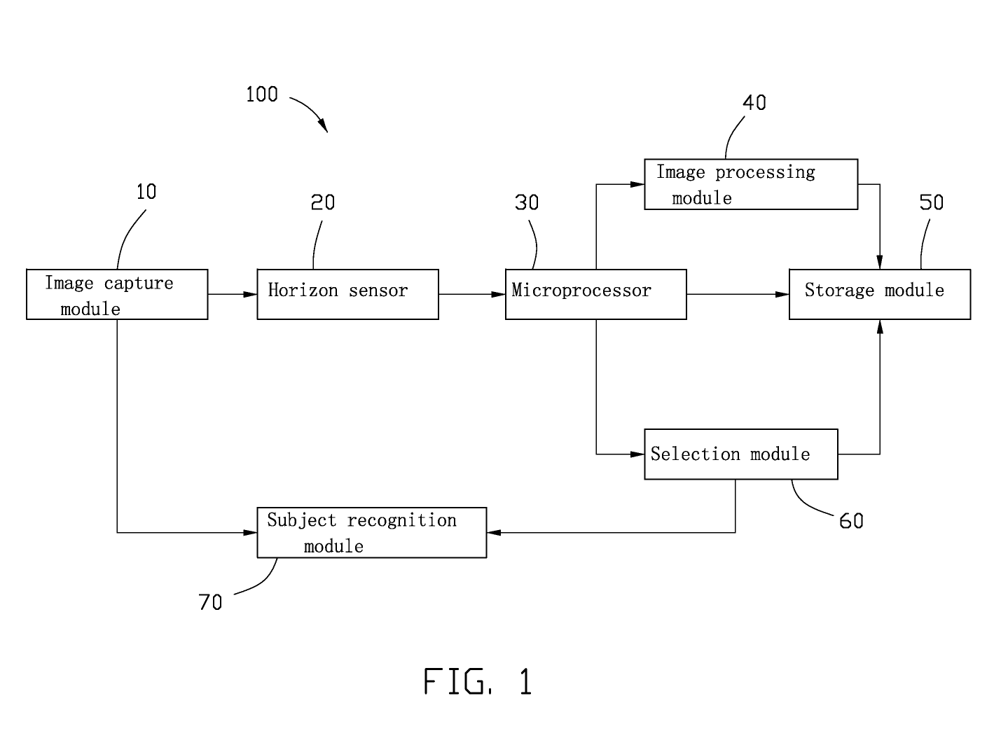

Referring to FIG. 1, an exemplary embodiment of an image capture device 100 includes an image capture module 10, a horizon sensor 20, a microprocessor 30, an image processing module 40, a storage module 50, a selection module 60, and a subject recognition module 70.

The image capture module 10 captures a primary image, and an image to be tested. The primary image is preset as an image of a target subject captured by the image capture module 10 with a first tilt angle relative to the horizon. The image to be tested is preset as an image of a subject to be tested and captured by the image capture module 10 with a second tilt angle relative to the horizon. The image capture module 10 may include a lens and a charge coupled device (CCD).

The horizon sensor 20 senses the first tilt angle and the second tilt angle of the image capture module 10 correspondingly. The microprocessor 30 receives the first tilt angle and the second tilt angle, transmits an image process command according to the first tilt angle to the image processing module 40, and transmits a selection command according to the second tilt angle to the selection module 60.

The image processing module 40 receives the image process command to rotate the primary image to different tilt angles relative to the first tilt angle, thereby generating a plurality of sample images at different tilt angles.

The storage module 50 stores the plurality of sample images and the corresponding tilt angles. The storage module 50 may be a compact flash (CF) card, an internal hard disk, or other.

The selection module 60 receives the selection command according to the second tilt angle of the image capture module 10, and selects a sample image with a corresponding tilt angle approximately the second tilt angle, from the plurality of sample images in the storage module 50 according to the selection command. In an example, the selection module 60 is preset to select a corresponding sample image with a tilt angle equal to the second tilt angle of the image capture module 10.

The subject recognition module 70 receives and compares the selected sample image from the selection module 60 and the image to be tested and captured by the image capture module 10 with the second tilt angle. If the image matches the selected sample image, the subject recognition module 70 outputs a first recognition signal indicating that the subject is the target subject. If the image does not match the selected sample image, the subject recognition module 70 outputs a second recognition signal to indicate that the subject is not the target subject. An example of the disclosed subject recognition method applied in the image capture device 100 follows.

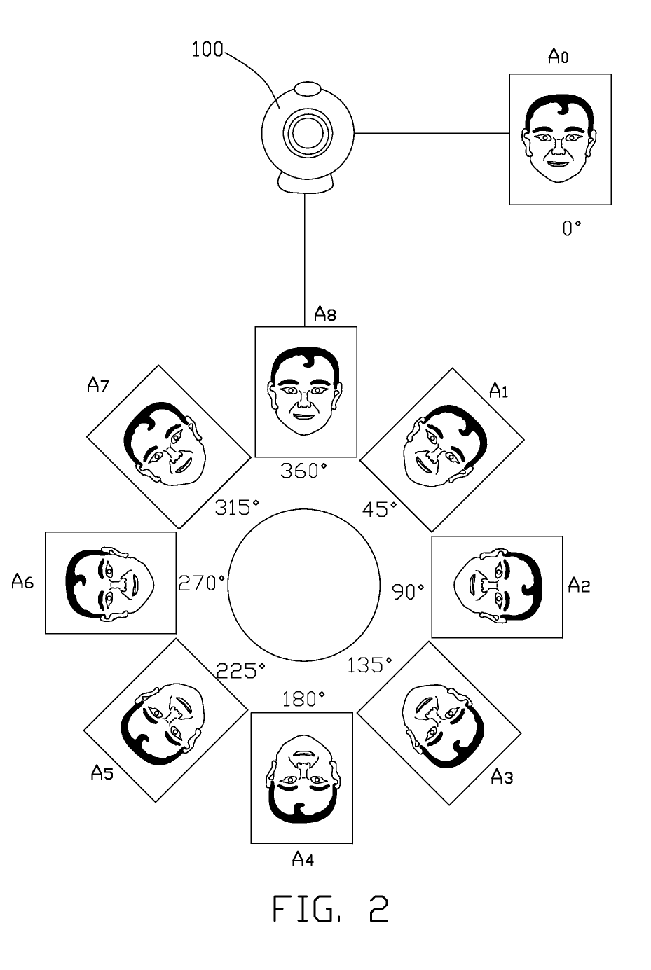

Here, the disclosed subject recognition method applied in the image capture device 100 is deployed in a site security system. Referring to FIG. 2, before use, the image capture module 10 captures a primary image A0 of a subject. The horizon sensor 20 senses a first tilt angle of about 0° of the image capture module 10.

The microprocessor 30 directs the image processing module 40 to rotate the primary image A0 from the first tilt angle of 0°, and generates a sample image at predetermined angles of rotation. Here, the image processing module 40 is set to generate a sample image at angles of rotation of about 45°. Image processing module 40, accordingly, generates eight sample images A1-A8 corresponding to tilt angles 45°, 90°, 135°, 180°, 225°, 270°, 315°, and 360°. The eight sample images A1-A8 and the corresponding tilt angles 45°, 90°, 135°, 180°, 225°, 270°, 315°, and 360° are correspondingly stored in the storage module 50. Alternatively, the image processing module 40 can be preset to generate a sample image at angles of rotation of about 1°, whereby the image processing module 40 generates 360 sample images, significantly increasing the precision of the image capture device 100.

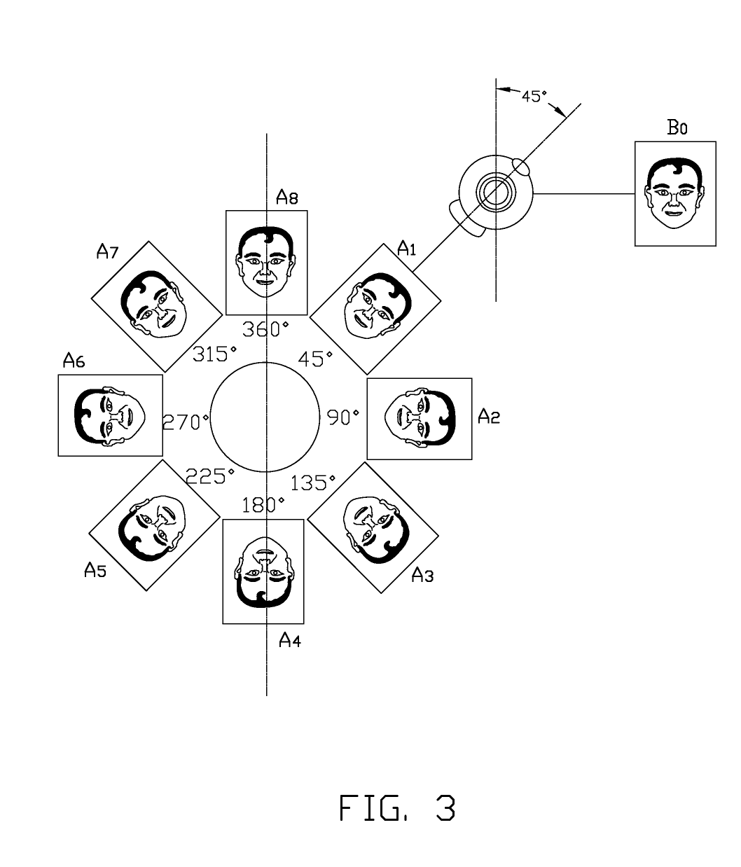

Referring to FIG. 3, in use, the image capture module 10 captures an image B0 of a subject and transmits the image B0 to the subject recognition module 70. The horizon sensor 20 senses the second tilt angle of the image capture module 10 capturing the testing image B0 as about 45°. The microprocessor 30 transmits a selection command according to the second tilt angle of about 45° to the selection module 60. The selection module 60 selects the sample image Al with the tilt angle 45°, and transmits the sample image A1 to the subject detection module 70.

The subject recognition module 70 compares the image B0 and the sample image A1. If the image B0 matches the sample image A1, the subject recognition module 70 outputs a first recognition signal indicating that the subject is recognized. The site security system allows entry accordingly. The subject recognition module 70 may further be preset to transmit a second recognition signal when the image B0 does not match the sample image A1, at which point the site security system refuses entry.

In other exemplary embodiments, the image capture device 100 can be used to recognize different subjects. The image capture device 100 generates different sample images of the different subjects according to the described method.

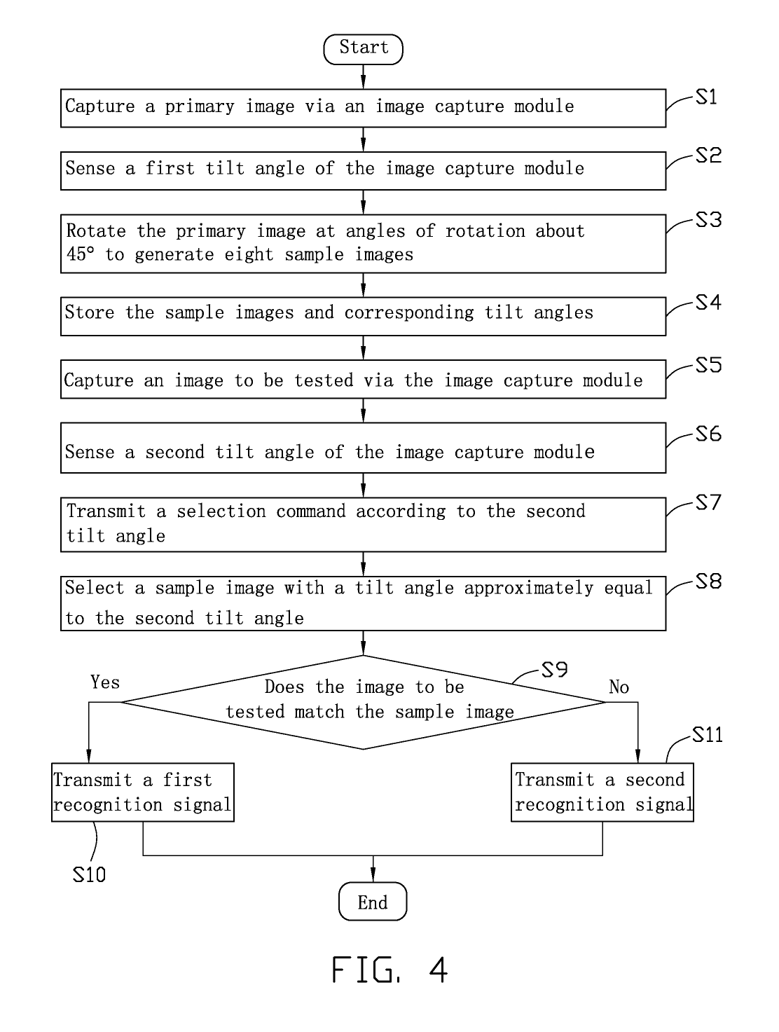

Referring to FIG. 4, an exemplary subject recognition method for the image capture device 100 is provided, as follows.

In step S1, the image capture module 10 captures a primary image A0 of a target subject.

In step S2, the horizon sensor 20 senses a first tilt angle of the image capture module 100 capturing the primary image A0.

In step S3, the microprocessor 30 directs the image processing module 40 to rotate the primary image A0 at angles of rotation about 45°, to generate eight sample images A1-A8 with different tilt angles.

In step S4, the storage module 50 stores the eight sample images A1-A8 and the corresponding tilt angles corresponding to the sample images A1-A8.

In step S5, the image capture module 10 captures an image B0 of a subject.

In step S6, the horizon sensor 20 senses a second tilt angle of the image capture module 10 capturing the image B0.

In step S7, the microprocessor 30 transmits a selection command to the selection module 60 according to the second tilt angle.

In step S8, the selection module 60 selects a sample image with a tilt angle approximately equal to the second tilt angle, and transmits the corresponding sample image to the subject recognition module 70.

In step S9, the subject recognition module 70 compares the image B0 from the image capture module 10 and the selected sample image from the selection module 60.

In step S10, the subject recognition module 70 outputs a first recognition signal when the image B0 matches the selected sample image.

In step S11, the subject recognition 70 transmits a second recognition signal when the image B0 does not match the selected sample image.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An image capture device, comprising:
an image capture module to capture an primary image of a target subject and an image of a subject to be tested;
a horizon sensor to sense a first tilt angle of the image capture module capturing the primary image and a second tilt angle of the image capture module capturing the image of the subject to be tested;
a microprocessor to transmit an image process command according to the first tilt angle and a selection command according to the second tilt angle;
an image processing module to receive the image process command to rotate the primary image at angles of rotation, therefore producing a plurality of sample images with different tilt angles;
a storage module to store the plurality of sample images and the corresponding tilt angles;
a selection module to receive the selection command from the microprocessor, and select a sample image from the storage module with a tilt angle approximately equal to the second tilt angle; and
a subject recognition module to receive the selected sample image from the selection module and the image of the subject to be tested from the image capture module, compare the image of the subject to be tested and the selected sample image, and transmit a first recognition signal when the image of the subject to be tested matches the selected sample image, thereby indicating that the subject to be tested is the target subject.

2. The device of claim 1, wherein the subject recognition module further transmits a second recognition signal when the image of the subject to be tested does not match the selected sample image, thereby indicating that the subject to be tested is not the target subject.

3. The device of claim 1, wherein the storage module is a flash memory device.

4. The device of claim 1, wherein the storage module is an internal hard disk.

5. The device of claim 1, wherein the subject recognition module is a face recognition system.

6. The device of claim 1, wherein the subject recognition module is a vehicle license plate recognition system.

7. A subject recognition method, comprising:
capturing a primary image of a target subject via an image capture module;
measuring a first tilt angle of the image capture module capturing the primary image relative to the horizon via a horizon sensor;
rotating the primary image at certain angles to generate a plurality of sample images with different tilt angles;
storing the plurality of sample images and the corresponding tilt angles;
capturing an image of a subject to be tested via the image capture module;
measuring a second tilt angle relative to the horizon of the image capture module capturing the image of the subject to be tested;
selecting a sample image with a tilt angle approximately equal to the second tilt angle from the plurality of sample images; and
comparing the selected sample image and the image of the subject to determine whether the subject to be tested is the target subject.

8. The method of claim 7, further comprising transmitting a first recognition signal when the image of the subject to be tested matches the selected image, indicating that the subject to be tested is the target subject.

9. The method of claim 7, further comprising transmitting a second recognition signal when the image of the subject to be tested does not match the selected image, indicating that the subject to be tested is not the target subject.

10. The method of claim 8, wherein the memory system is a flash memory device.

11. The method of claim 8, wherein the memory system is an internal hard disk.
